(19) United States
(12) Patent Application Publication
(10) Pub. No.: US 2024/0365767 A1
(43) Pub. Date: Nov. 7, 2024

(54) DEPLOYABLE DRONE WITH CONFIGURABLE SPRAY FUNCTIONALITY

(71) Applicant: Martin Schwartz, Suffern, NY (US)

(72) Inventor: Martin Schwartz, Suffern, NY (US)

(21) Appl. No.: 18/653,882

(22) Filed: May 2, 2024

Related U.S. Application Data
(60) Provisional application No. 63/463,364, filed on May 2, 2023.

(51) Int. Cl. A01M 1/20; B64U 20/87; B64U 101/28; B64U 101/45

(52) U.S. Cl. CPC A01M 1/2022; B64U 20/87; A01M 2200/012; B64U 2101/28; B64U 2101/45; B64U 2201/10

(57) ABSTRACT

An extermination drone may include a transceiver; at least one detection sensor configured to detect a stinging insect; a processor communicatively connected to the at least one detection sensor and transceiver; a power supply electrically connected to the transceiver, the at least one detection sensor, and the processor; at least one propulsion means; and an insecticide treatment dispenser communicatively connected to the transceiver. The insecticide treatment dispenser may be configured to dispense an insecticide upon receiving a first signal.

### FIELD OF THE INVENTION

The present disclosure relates to an extermination drone. More specifically, the present disclosure relates to a drone, which may be configured to spray substances, such as insecticide.

### INTRODUCTION

Many people have issues with flying stinging insects. Some people have allergies that are life-threatening if stung by certain insects. Accordingly, it is difficult and dangerous for these people in particular to exterminate flying stinging insects.

When exterminating such nests, there is a risk of the insecticide splashing or blowing onto the user's face, mouth, eyes, mucous membranes, or body. While an individual may don protective gear, this is time-consuming, cumbersome, and inconvenient.

It would be desirable to provide a way of remotely removing stinging insect nests. It would further be desirable if this remote way of removing stinging insect nests was mounted on a drone that can either be operated or autonomously apply the insecticide to the stinging insect nest.

### BRIEF SUMMARY

In an embodiment, the invention of the present disclosure includes a drone comprising a transceiver, at least one detection sensor, a processor communicatively connected to the at least one detection sensor and transceiver, a power supply electrically connected to the transceiver, the at least one detection sensor, and the processor, at least one propulsion means, and a treatment dispenser communicatively connected to the transceiver.

In one embodiment, the drone is an extermination drone and the at least one detection sensor is configured to detect an insect. In some embodiments, the at least one detection sensor is configured to detect a particular characteristic of the insect, including for example, whether the insect is a stinging insect. Of course, other characteristics may be detected.

In an embodiment, the treatment dispenser is an insecticide treatment dispenser configured to dispense an insecticide upon receiving the first signal. Of course, other embodiments of treatment dispensers are contemplated, including, without limitation, for use with paint, agricultural seeding and pesticides, or any use that a person of ordinary skill in the art may desire.

In some embodiments, the drone, further comprises a non-transitory memory communicatively connected to the processor. The memory comprises instructions to detect a characteristic from the at least one detection sensor. For example, in one embodiment, the memory may comprise instructions operative to identify the stinging insect.

In one embodiment, the memory may further comprise instructions to do any of map a location of the identified stinging insect, follow the
identified stinging insect until a stinging insect nest is identified,
identify a stinging insect nest, automatically apply the insecticide to the identified stinging insect nest and/or indicate to a user that a stinging insect nest has been identified.

In one embodiment, the drone, further comprises a nest remover member, wherein the nest remover member is any of a probe, saw, fork, claw, grasping mechanism, torch, or chemical agent capable of dissolving stinging insect nests. Of course, any nest remover member that a person of ordinary skill in the art may desire is contemplated.

In some embodiments, the nest remover member is communicatively connected to the transceiver and transitions from a deactivated to an activated state in response to a second signal.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a networked environment of the drone according to one embodiment.

FIG. 2 illustrates a blocked diagram of one embodiment of the drone.

### DETAILED DESCRIPTION

For this disclosure, singular words should be construed to include their plural meaning, unless explicitly stated otherwise. Additionally, the term “including” is not limiting. Further, “or” is equivalent to “and/or,” unless explicitly stated otherwise. Although ranges may be stated as preferred, unless stated explicitly, there may exist embodiments that operate outside of preferred ranges.

A drone comprising a transceiver configured to send and receive information with a remote user device comprising a user device transceiver configured to send and receive information from the drone transceiver.

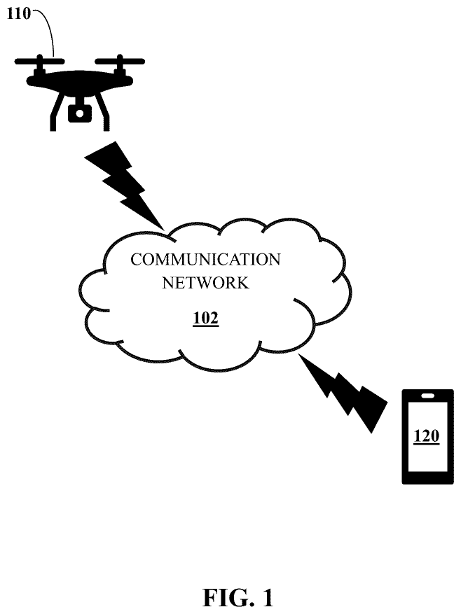

FIG. 1 is illustrative of a communication network 102 environment in which an embodiment of a drone communication system is implemented. As shown in FIG. 1, the networked environment may comprise a drone 110 and a remote computer device 120 associated with a user. The drone 110 and the remote user device 120 are illustrated as communicatively coupled across a communication network 102. In the embodiment illustrated, the remote user device is illustrated as a smartphone, however, any of a tablet, laptop computer, desktop computer, or other computing means that incorporates Wi-Fi, Bluetooth, and/or cellular telephone technology is contemplated. Further, the communication network 102 may use one or more communication types that are known in the art, including for example and without limitation, wired, cellular, Wi-Fi, and Bluetooth communications.

The communication network 102 may comprise a plurality of baser stations and/or signal repeaters that are configured to serve as intermediary connections between the drone 110 and the remote user device 120.

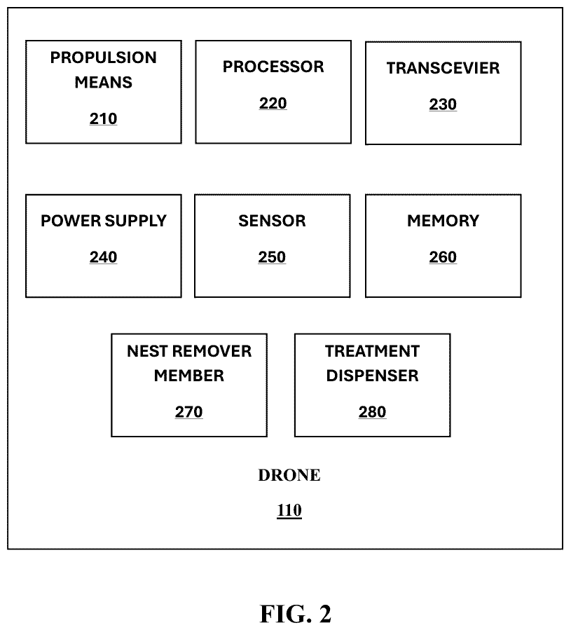

A block diagram embodiment of the drone 110 is illustrated in FIG. 2 for use with insect removal. The drone 110 may comprise a propulsion means 210, a processor 220, a transceiver 230, a power supply 240, a at least one detection sensor 250, a memory 260, a nest remover member 270, and a treatment dispenser 280. It is contemplated that any of the components may be specific to the contemplated use of the drone and may vary according to the contemplated use.

Returning to FIG. 2, the drone 110 may be any drone that a person of ordinary skill in the art may desire, including, for example and without limitation, a quadcopter, airplane, car, tracked vehicle, or similar design. The propulsion means 210 may be any propulsion means 210 that a person of ordinary skill in the art may desire. In some embodiments, the drone 110 may comprise a plurality of propulsion means. For example, the drone may have wheels, tracks, wings, and/or propellors. If the drone is configured with multiple propulsion means 210, then the processor 220 may be configured to receive a signal that causes the drone to change from one propulsion means to another propulsion means. For example, a drone comprising wheels and propellors may a processor configured to switch the drone from land to air capabilities by switching operation from the wheels to the propellors.

In one embodiment, the propulsion means 210 may optionally be used as the nest remover member 270 to aid in extermination or nest destruction. For example, the propulsion means 210 may be configured as propellors made out of a sufficiently durable material, or reinforced on a leading edge of the propellor to chop up insects or their nest. In one embodiment, the drone propellors may comprise propellor guards the prevent the blades from being damaged if the propellor impacts an unintended object. An axis on which the propellor blades rotate and are attached to the drone at may have a variety of attachment mechanism. They may be mechanically attached by friction fit, have a locking mechanism, magnetically attached, or be non-removably attached.

In one embodiment, the drone 110 may be modular, with any of the components configured to be interchanged. For example, in an embodiment, the drone 110 may comprise ports designed to receive a plurality of propulsion means 210 capable of being interchanged. In some embodiments, there is a plurality of ports that initially power and/or control wheel modules, which can be replaced by propellor modules. The modules may comprise their own power supply or may receive power from the power supply 240 of drone 110.

The power supply 240 may be any of a battery, an electric generator, an alternator, solar panel, and/or combustion engine. Of course, other power supplies 240 are contemplated and the aforementioned are provided as non-limiting examples only. The power supply 240 may be electronically coupled to any of the components in the drone 110 to provide power. In one embodiment, the drone 110 may be configured to interface with a base station where it may manually or autonomously swap out components, power supply, recharge or refill a fuel reservoir.

The processor 220 may be configured to perform a variety of operations. For example, the processor 220 may comprise software that instructs the drone to autonomously move, search for stinging insects and their nests, track and follow stinging insects, follow stinging insects, identify and map stinging insects and their nests from the at least one detection sensor 250, map the locations of identified stinging insects and their nests, create a task list of pesticide treatments for the identified stinging insects and nests, select the appropriate treatment method, and execute the treatment method. For example, the drone 110 may detect a hornet flying, and the drone proceeds to track the hornet back to its nest where the nest is underground, so the drone determines that the stinging insect is a ground hornet. In some embodiments, the software may utilize artificial intelligence and/or machine learning programs. In one embodiment, the drone 110 may return to a base station to charge. Further, in some embodiments returning to the base station may permit the drone 110 to receive additional modules and/or treatments to assist in the removal of the insects. Afterward, the drone may search for other ground hornet locations to be treated. The at least one detection sensor 250 may detect, for example, visual or audio evidence of a bechive. The drone 110 may return to the base station after treating the ground hornets to be reconfigured to treat the bee infestation. The drone 100 may switch to the propellor modules, a different insecticide, for example, a gas or aerosol spray with nest dissolver, and return to the location the bees were detected, and follow them to their nest for administering the insecticide.

The drone 100 may comprise a variety of at least one detection sensors 250 configured to detect a variety of stinging insects. In some embodiments, the at least one detection sensor 250 may comprise a camera with computer vision trained to detect insect species and discern beneficial insects with undesirable stinging insects. In another embodiment, the at least one detection sensor 250 may comprise one or more microphones configured to determine a frequency of the detected insect and use that frequency to determine the species of insect. For example, the drone 110 may comprise an array of microphones and use the difference in detection of each of the microphones to locate the insect in 2D or 3D space. In one embodiment, the drone 110 may be configured with software that provides a report of each detected insect type, where a user of the drone system may select a subset of the insects and designate only the subset for treatment.

In an embodiment, the processor 220 and the memory 260 may be capable of storing an area to be inspected at a predetermined interval to determine if treatment is necessary. The drone 110 may also, in some embodiments, store a location of one or more base stations to store and/or charge the drone 110 when not in use. The base station may be configured with a variety of charging solutions, for example, the drone 100 may be capable of wireless charging so that when the drone 110 returns to the base station no user interaction is required to recharge the battery. However, other charging solutions are contemplated and the aforementioned are provided as non-limiting examples only.

in one embodiment, the nest remover member 270 may comprise a probe and/or a protrusion that may be fixed, retractable, and/or deployable manually or remotely via a signal received by the transceiver 230 and/or processor 220. Upon receiving the signal, the nest remover member 270 may transition from an activated to deactivated state. In some embodiments the nest remover member 270 may comprise a pair of electrically actuated scissors or saw, and the signal may cause the scissors to open or close or the saw to begin sawing. In another embodiment the nest remover member 270 may transition from a deployed to a undeployed state upon receiving a signal. In some embodiments, the nest remover member 270 may be a bladed nest remover member. It is contemplated that it may be desirable to have the blade retract to an undeployed state when traveling to and from the location of the nest. In another embodiment, the nest remover member 270 may be a rod, saw, bladed/edge, compressed gas or pressurized fluid, or similar mechanical structure. In some embodiments, the nest remover member 270 may comprise be a chemical agent, such as, and without limitation to solvents, acids, bases, pyrotechnic or pyrophoric chemicals, combustible chemicals, or similar chemical agents.

The treatment dispenser 280 may be one or more, optionally modular, treatment dispensers. In some embodiments, the treatment dispenser 280 may comprise spray nozzles, with a variety of different spray patterns, such as a narrow or wide cone, vertical or horizontal spray, a narrow stream, etc. Other embodiments may include a fogger or aerosolizer. The nozzle may be adjustable either manually, remotely with the aid of the transceiver 230 and/or processor 220, or dynamically using machine learning, or a computer program executed by the processor to dynamically adjust the spray pattern and/or range of the spray based on the conditions encountered during operation of the drone. It is contemplated that the nozzle may be interchangeable for different spray patterns. The nozzles may be changed manually when not in use or may be changed by the drone 110 during operation. In some embodiments, this may be accomplished by using a revolver mechanism, a carousel, or variety of shaped orifices to manipulate the flow pattern of the fluid. For this application, the term fluid can be used to understand both gasses and liquids.

The treatment dispenser 280 may, in some embodiments, comprise a variety of spraying, fogging, streaming, misting, etc. mechanisms. In some embodiments these may include spray nozzles, or a fogger canister that may be deployed by the drone 110 over a wide area to apply a treatment over a wide area. The drone 100 may also comprise a pressurization system to power a high-pressure stream or continuous mist or atomization. The pressurization system could be mechanically, thermally, or electrically pressurized. In some embodiments, the drone 110 may be configured to use proprietary or non-proprietary off the shelf insecticide or fogger solutions with a mechanism on the drone to trigger the deployment of fogger upon a signal transmitted to the drone.

The drone 110 may include a reservoir capable of being refilled or a replaceable cartridge containing the insecticide in fluid communication with the treatment dispenser 280. The drone 110 may comprise software that dynamically compensates for a liquid payload on the drone 110 that shifts during locomotion. The treatment dispenser may include an assembly with a gimbal capable of 2D or 3D motion and/or a separate camera that enables easier aiming and treatment application.

The treatment dispenser 280 may be remotely operated. In some embodiments, the dispensing may be started after receiving a signal and stopped after receiving another signal. The treatment dispenser 280 may comprise any of an actuator, plunger, trigger, solenoid, etc. that starts and/or stops the treatment being dispensed. The treatment may be under pressure, or pressure may be generated by mechanical or electrical means, for example, a plunger may compress the reservoir causing the treatment to be administered, or the insecticide and/or additive may have a low boiling point which causes a phase change when electrically heated that causes the treatment to be dispensed. The drone 110 may comprise a variety of mechanisms to carry multiple insecticides. In some embodiments, this may be a multichambered reservoir, a revolving cartridge mechanism, etc.

In some embodiments, any of the at least one detection sensor 250 of the drone, nest remover member 270, the treatment dispenser 280, or any other component may comprise pulse width modulation or other electric signal modulation to increase performance in said component. In one embodiment, the treatment dispenser 280 may be controlled by a digital circuit and may be capable of rapidly starting and stopping dispensing a treatment. Because of size and weight constraints associated with power supply 240 of aerial drones, using signal modulation to rapidly turn the spraying/fogging/dispensing mechanism on and off may increase the duration and/or area in which the treatment may be dispensed.

In an embodiment, the nest remover member 270 may comprise an optionally deployable extension for the destruction and/or detachment of the nest. This extension may be a fork, a probe, a saw, a torch, a claw, etc. In another embodiment, the drone 110 may be equipped with a chemical agent capable of dissolving the nest, this chemical agent may be mixed in with the insecticide or may be in a separate reservoir.

In some embodiments, the drone 110 may be equipped with one or more light sources. These light sources may be LEDs, operating in the visible spectrum, infrared spectrum, or any spectrum capable of being detected by the at least one sensor 250.

In some embodiments the at least one sensor 250 may be an infrared camera with an optional infrared illuminator to allow for operation in low light conditions or at night when certain insects may be more or less active. For individuals at risk for stinging insect anaphylaxis, the ability to operate the drone at times when insects are less active could be advantageous. Applying the treatment when the insects are less active may provide the advantage of more complete extermination and leaving less insects surviving the treatment. Alternatively, some insecticides may be more volatile compounds that degrade quickly, therefore application when the insects are more active could be desirable to expose more to the insecticide and their increased metabolic activity will cause quicker onset of the insecticide effects.

The drone 110 may also provide an indication of when the identified insects are most and/or least active. The drone 110 may comprise multiple cameras that may be switched between, or the video of each fused together to see a broader spectrum and allow the operator, drone, and/or computer vision to have more data to act on. For example, certain animals/insects have vision that goes into the infrared and ultraviolet spectrum. Accordingly, said animals/insects often have patterns and markings that are not visible using the visible light spectrum. The infrared camera allows some embodiments to have more data to use when deciding when treatment is appropriate.

In one embodiment, the drone 110 may optionally comprise a bug zapper. For example, many insects are attracted to UV light sources, the drone 110 may include one or more UV LEDS, the drone 110 may then include an electrified wire mesh, or similar mechanism to electrocute insects. The electrified portion of the drone 110 may be continuously powered, powered at regular or irregular time intervals, or may be equipped with a capacitance or resistance sensor that detects when an insect or other conductive object comes into contact with the drone to provide power to electrify the mesh to kill the insect. The capacitance or resistance sensor may be tuned to a certain range and/or include a ground and/ground fault sensor so that the drone will not short circuit, electrocute larger animals such as birds, cats, dogs, people, fish, etc. Including a sensor or pulsed power modulation may provide the additional benefit of saving power and increasing battery life and operation duration of the drone.

In some embodiments, the drone 110 may comprise speakers or motors tuned to a specific frequency or frequencies that stimulate stinging insects, causing them to return to their nest. The use of this frequency may permit the drone 110 to find a nest more quickly by following the frequency stimulated stinging insect back to the nest.

In an embodiment, the drone 110 may also be equipped with any of an array of speakers, motors, or other noise emitters tuned to repel insects. The drone 110 may also, in some embodiments, be configured to follow a designated person or object. In some embodiments the drone 110 may follow a person while emitting the noise to prevent insects from coming into contact with the person or object.

In an embodiment, the drone 110 may be configured to automatically travel certain patterns. For example, in terrestrial configurations, the drone 110 may be configured to autonomously patrol a line, grid, diagonal, spiral, or other pattern. In aerial configurations, for example, the drone 110 may be configured to perform similar patterns while varying height above ground or compensating for changes in height above ground. The drone 110 may, in some embodiments, be configured to make multiple passes over an area. In some embodiments the drone 110 may be configured with multiple chemicals, a first sprayed at a greater height and a second sprayed at a lower height. In one example, the drone 110 may have a fogger to be deployed at a greater height to do a wide area, and a downward facing sprayer to be sprayed at a lower height. In one embodiment, the memory 260 may contain several preloaded patterns that the drone 110 may follow. However, in other embodiments, the pattern may be drawn on a device and then transmitted to the drone 110, waypoints or coordinates may be entered, or may be downloaded from the internet or another device.

In another embodiment, not shown, a drone may be configured to spray paint on hard-to-reach areas. The drone may be equipped with a paint applicator, spray nozzle, paint reservoir, hardware such as acoustic, laser, or radar range finders, wind speed monitors, and at least one detection sensors to detect painted and unpainted portions of a structure. The drone may have a paint applicator module, which may be configured to accept and utilize off the shelf commercial solutions such as spray cans, electric or pneumatic spray guns, atomizers, or airbrush spray guns. The drone may use paint cartridges, a tank/reservoir, spray cans, or a roller/brush attachment that dips into a paint bucket as a paint source.

The drone may use the range finders, windspeed monitors, and/or the at least one detection sensors to monitor coats of paint as they are applied to a structure. The drone may be configured with different software programs for different types of coatings. For example, certain paints may take longer to dry than other types, lacquers, base coats, and glosses may have different application styles. It is contemplated that the drone configured to spray paint may comprise any of the characteristics and/or components described with reference to drone 110 in FIG. 2.

The air temperature, UV level, air speed, relative humidity, etc. all may affect the drying speed of coats to be applied to a building. The drone may be configured to automatically detect and enter, or manually enter these values and automatically carry out a coating procedure for a structure. The drone may be configured to automatically return to its base station to optionally refill on paint and recharge its battery.

In some embodiments, the drone may be configured to inspect a fresh coat of paint on a building. The drone may use its at least one detection sensors to look for under or over painted spots and either apply more paint to undercoated spots, apply paint thinner to overcoated spots, or send an alert to the user with a picture and location of the under or over painted spot for subsequent remedial measures.

The drone may use a variety of patterns to apply the paint, in low wind environments a grid pattern may be optimal, whereas on windy days due to the risk of overspray or uneven application the drone may alter the altitude or application pattern to counteract the wind. The drone may be configured with software that allows the user to virtually tape off areas not to be painted, and if paint is detected in the virtually taped off areas the drone may apply paint remover to said areas and/or provide an alert to the user.

The drone may also be configured with computer vision to detect what the taped off area is, and if said taped off area is made of plastic for example, the drone will not apply certain solvents which dissolve the taped off material. For example, acetone dissolves and discolors plastic, the drone would know not to apply acetone to plastic areas.

In some embodiments, the drone and any of its components and parts may be constructed from a variety of different materials, these may include but are not limited to, plastics, metals, alloys, composites, fabrics, wood, etc. These may be produced according to various manufacturing methods, including but not limited to, injection molded plastics, additive or subtractive manufacturing, 3-D printing. The device may be shipped in a partially constructed state, or in a parts kit to be constructed by the user. The parts, or a subset thereof may also be available online to be printed by the user with the aid of a 3-D printer.

While this invention has been described in conjunction with the embodiments outlined above, many alternatives, modifications, and variations will be apparent to those skilled in the art upon reading the foregoing disclosure. Accordingly, the embodiments of the invention, as set forth above, are intended to be illustrative, not limiting. Various changes may be made without departing from the spirit and scope of the invention.

What is claimed is:

1. An extermination drone comprising:
a transceiver;
at least one detection sensor configured to detect a stinging insect;
a processor communicatively connected to the at least one detection sensor and transceiver;
a power supply electrically connected to the transceiver, the at least one detection sensor, and the processor;
at least one propulsion means; and
an insecticide treatment dispenser communicatively connected to the transceiver, wherein the insecticide treatment dispenser is configured to dispense an insecticide upon receiving a first signal.

2. The extermination drone of claim 1, further comprising non-transitory memory communicatively connected to the processor, the memory comprising instructions to perform the following operations:
identify the stinging insect.

3. The extermination drone of claim 2, wherein the operations further comprise:
map a location of the identified stinging insect.

4. The extermination drone of claim 2, wherein the operations further comprise:
follow the identified stinging insect until a stinging insect nest is identified.

5. The extermination drone of claim 1, wherein the operations further comprise:
identify a stinging insect nest.

6. The extermination drone of claim 5, wherein the operations further comprise:
automatically apply the insecticide to the identified stinging insect nest or indicate to a user that a stinging insect nest has been identified.

7. The extermination drone of claim 1, further comprising a nest remover member, wherein the nest remover member is any of probe, saw, fork, claw, grasping mechanism, torch, or chemical agent capable of dissolving stinging insect nests.

8. The extermination drone of claim 7, wherein the nest remover member is communicatively connected to the transceiver and transitions from a deactivated to an activated state in response to a second signal.

9. A painting drone comprising:
a transceiver;
at least one sensor configured to detect an unpainted area of a structure;
a processor communicatively connected to the at least one sensor and transceiver;
a power supply electrically connected to the transceiver, the at least one sensor, and the processor;
at least one propulsion means; and
a treatment dispenser communicatively connected to the transceiver, wherein the treatment dispenser is configured to dispense any of a paint, solvent, gloss, or lacquer upon receiving a first signal.

10. The painting drone of claim 9, wherein the drone is configured to use a spray paint can.

11. The painting drone of claim 9, wherein a user designates an area where paint is to be applied; and
when the at least one sensor detects paint outside of the designated area, the painting drone applies a solvent to the paint outside of the designated area.

12. The painting drone of claim 9, wherein the processor is configured to detect an underpainted area and the processor causes the drone to touch up and blend in the underpainted area.

13. The painting drone of claim 9, wherein the processor is configured to detect an overpainted area; and
in response the processor causes the drone to apply a solvent to thin the overpainted area and send a notification to a user comprising the overpainted area.
